(19) United States
(12) Patent Application Publication
(10) Pub. No.: US 2020/0410503 A1
(43) Pub. Date: Dec. 31, 2020

(54) Conditional Transaction Pre-Approval

(71) Applicant: PayPal, Inc., San Jose, CA (US)

(72) Inventors: Prashant Jamkhedkar, Fremont, CA (US); Ali Aghareza, Berkeley, CA (US); Thomas M. Whipple, Austin, TX (US); Kin K. Kee, Alameda, CA (US); Archana N. Puri, San Ramon, CA (US); Kumar Ashwani, Milpitas, CA (US); Vijay Venugopal, San Jose, CA (US); Alan F. Eng, San Francisco, CA (US); Prashant Shah, San Jose, CA (US)

(21) Appl. No.: 16/458,045

(22) Filed: Jun. 29, 2019

(51) Int. Cl. G06Q 20/42; G06N 20/00; G06Q 20/40

(52) U.S. Cl. CPC G06Q 20/42; G06Q 20/405; G06N 20/00

(57) ABSTRACT

A method and apparatus for conditional transaction pre-approval is disclosed. In one embodiment, a computer system receives a transaction request, the computer being configured to perform a verification process to authorize transactions. The computer system may initiate, prior to completion of the verification process for a transaction, a prediction process using a model, to predict whether the transaction will pass the verification process. In response to determining that the transaction is predicted to pass, the transaction is pre-approved by the computer system, prior to completing the verification process. Subsequent to pre-approving, the verification process may be completed to determine if the prediction was correct. Based on the result of the verification process, the model is updated for future transaction requests.

### BACKGROUND

### Technical Field

This disclosure is directed to transaction processing systems, and more particularly, various aspects of transactions conducted in transaction processing systems.

### Description of the Related Art

Transaction processing services are ubiquitous today and provide a wide variety of services to users, including facilitating electronic payment for goods and services. Within the context of transaction processing, some transactions are necessarily completed in less time than others. Where quality of service is deemed important, some users of transaction processing systems, such as merchants, may have service-level agreements (SLAs) with a transaction processing service that specifies various quality of service parameters relating to transactions performed by the system. One such example is average latency for transaction over a specified time period. Even when there is not a particular SLA in place, it is beneficial to minimize transaction latency, such as to improve the end-user experience.

### SUMMARY

A method and apparatus for conditional transaction pre-approval is disclosed. In one embodiment, a computer system receives a transaction request, the computer being configured to perform a verification process to authorize transactions. The computer system may initiate, prior to completion of the verification process for a transaction, a prediction process using a model to predict whether the transaction will pass the verification process. In response to (and under the condition of) determining that the transaction is predicted to pass, the transaction is pre-approved by the computer system, prior to completing the verification process. Subsequent to pre-approving, the verification process may be completed to determine if the prediction was correct. Based on the result of the verification process, the model is updated for future transaction requests.

In some implementations, the conditional pre-approval may be determined by a prediction process. The prediction process, in some cases, may constitute a first set of routines executable to determine eligibility for pre-approval of a particular transaction, and a second set of routines executable to determine, based on the first set of routines as well as other factors, whether the transaction request is pre-approved. The second set of routines may be executed in response to the first set of routines indicating eligibility for pre-approval and a duration of the verification process approaching a specified timeout threshold. The specified timeout threshold may correspond to a quality of service parameter (e.g., a desired latency) for a particular tenant.

In some implementations, the first and second routines may be executed on different computer systems with different functions within a larger transaction processing system operated by a payment service provider. For example, a transaction processing system may include a first computer system that is coupled both to receive payment requests from merchants and to a second computer system that uses account information for a payment service provider to process payments. In such an architecture, the first set of routines may execute on the first computer system and the second set of routines may execute on the second computer system.

In some embodiments, conditional pre-approval may be based on a loss budget, which may correspond to a particular party in a transaction. For example, in a payment processing system of a payment service, pre-approval may constitute the payment service assuming liability for a pre-approved transaction, even if it is subsequently determined that the transaction should have been declined. Accordingly, a loss budget may be implemented that corresponds to how much risk a payment service is willing to incur during a particular time period.

### BRIEF DESCRIPTION OF THE DRAWINGS

The following detailed description makes reference to the accompanying drawings, which are now briefly described.

FIG. 1 is a block diagram of one embodiment of a transaction processing system.

FIG. 2 is a block diagram illustrating another embodiment of a distributed transaction processing system.

FIG. 3 is block diagram illustrating various components of a transaction processing system.

FIGS. 4A and 4B are block diagrams illustrating respective embodiments of a prediction module used in various embodiments of a transaction processing system.

FIG. 5 is a block diagram illustrating one embodiment of a verification module used in various embodiment of a transaction processing system.

FIG. 6 is a timing diagram illustrating one embodiment of a method for conducting a transaction in a distributed transaction processing system.

FIG. 7 is a timing diagram illustrating another embodiment of a method for conducting a transaction in a distributed transaction processing system.

FIG. 8 is a timing diagram illustrating another embodiment of a method for conducting a transaction in a distributed transaction processing system.

FIG. 9 is a timing diagram illustrating another embodiment of a method for conducting a transaction in a distributed transaction processing system.

FIG. 10 is a flow diagram illustrating one embodiment of a method for conducting a transaction.

FIG. 11 is a flow diagram illustrating another embodiment of a method for conducting a transaction.

FIG. 12 is a block diagram of one embodiment of an example computer system.

Although the embodiments disclosed herein are susceptible to various modifications and alternative forms, specific embodiments are shown by way of example in the drawings and are described herein in detail. It should be understood, however, that drawings and detailed description thereto are not intended to limit the scope of the claims to the particular forms disclosed. On the contrary, this application is intended to cover all modifications, equivalents and alternatives falling within the spirit and scope of the disclosure of the present application as defined by the appended claims.

This disclosure includes references to “one embodiment,” “a particular embodiment,” “some embodiments,” “various embodiments,” or “an embodiment.” The appearances of the phrases “in one embodiment,” “in a particular embodiment,” “in some embodiments,” “in various embodiments,” or “in an embodiment” do not necessarily refer to the same embodiment. Particular features, structures, or characteristics may be combined in any suitable manner consistent with this disclosure.

Reciting in the appended claims that an element is “configured to” perform one or more tasks is expressly intended not to invoke 35 U.S.C. § 112(f) for that claim element. Accordingly, none of the claims in this application as filed are intended to be interpreted as having means-plus-function elements. Should Applicant wish to invoke Section 112(f) during prosecution, it will recite claim elements using the “means for” [performing a function] construct.

As used herein, the term “based on” is used to describe one or more factors that affect a determination. This term does not foreclose the possibility that additional factors may affect the determination. That is, a determination may be solely based on specified factors or based on the specified factors as well as other, unspecified factors. Consider the phrase “determine A based on B.” This phrase specifies that B is a factor that is used to determine A or that affects the determination of A. This phrase does not foreclose that the determination of A may also be based on some other factor, such as C. This phrase is also intended to cover an embodiment in which A is determined based solely on B. As used herein, the phrase “based on” is synonymous with the phrase “based at least in part on.”

As used herein, the phrase “in response to” describes one or more factors that trigger an effect. This phrase does not foreclose the possibility that additional factors may affect or otherwise trigger the effect. That is, an effect may be solely in response to those factors, or may be in response to the specified factors as well as other, unspecified factors.

As used herein, the terms “first,” “second,” etc. are used as labels for nouns that they precede, and do not imply any type of ordering (e.g., spatial, temporal, logical, etc.), unless stated otherwise.

In the following description, numerous specific details are set forth to provide a thorough understanding of the disclosed embodiments. One having ordinary skill in the art, however, should recognize that aspects of disclosed embodiments might be practiced without these specific details. In some instances, well-known, structures, computer program instructions, and techniques have not been shown in detail to avoid obscuring the disclosed embodiments.

### DETAILED DESCRIPTION OF EMBODIMENTS

The present disclosure is directed to a transaction processing system that is configured to utilize a prediction process that is capable of conditionally pre-approving transactions. In many instances, a payment service provider operating the transaction processing system may have agreements with parties that use its service that specify quality of service parameters. For example, a transaction processing service may have an agreement in place (e.g., an SLA, as discussed above) with a particular user that specifies an overall average latency for verifying transactions with that user (e.g., a specified average duration of 2.5 seconds). In some cases, the transaction processing system may incur financial penalties to the user in some cases if this parameter is not met over some time period. Since the verification for some transactions may take longer than the specified duration to complete, the present disclosure contemplates that it may be desirable to implement a process for pre-approving selected transactions, thereby helping the transaction processing system to meet the various quality of service agreements of the payment service processor.

Consider a transaction processing system that has a verification process for verifying transactions. The system may be advantageously adapted to include a prediction process, separate from the verification process, that is executable to predict whether a transaction is to be pre-approved, meaning that the transaction will be indicated as approved regardless of whether the transaction would have been approved according to the verification process. Once a transaction is pre-approved, the parties involved in the transaction will be notified that the transaction is approved. In the context of a payment service provider, the merchant will thus ultimately receive funding for the transaction. This occurs regardless of the verification process results, meaning that the payment service provider has, in effect, assumed the risk of the transaction. By implementing the techniques and/or methods discussed by the present disclosure, a merchant will still be paid for a transaction even if a user funding instrument is ultimately determined to fail. If the prediction process is performed accurately, however, any such mispredictions will be acceptably low. This paradigm will allow the service to consistently meet quality of service parameters and also provide an improved experience to end users. In some cases, following the pre-approval, the verification process may be allowed to complete to determine whether or not the prediction was correct, which may in turn be used to improve the prediction process.

In various embodiments, the prediction process includes a first set of routines used to determine if a particular transaction is eligible for pre-approval, and a second set of routines used to predict whether the transaction will pass the verification process. Transactions predicted to pass the verification process are, in many cases, pre-approved; pre-approval may also depend on other factors, such as the verification process not completing as it approaches a timeout threshold that corresponds to the merchant. If the first set of routines determines that a particular transaction is not eligible for pre-approval, in some cases, no prediction is performed using the second set of routines. If the second set of routines predicts that a transaction will not pass the verification process, no pre-approval is issued. Thereafter, the verification process may complete, and the transaction will ultimately be approved or denied based on the results thereof.

The prediction process in various embodiments utilizes a machine-learning model. Because the characteristics of transactions that should be approved may differ between different users of the transaction processing system (e.g., different merchants of a payment service provider such as PAYPAL), in some cases a different machine-learning model may be used for each user. Merchant/user specific models may thus have particular feature sets tailored thereto. In building a particular model, training is conducted using historical transaction data, ideally for the particular merchant/user. Subsequently, after the model is deployed, it may be updated with data from completed predictions, which are compared with actual verification results to determine if they were correct or not. The verification results may be compiled as collected statistics that are used to update the model in order to provide a prediction history and enhance future prediction accuracy. Increasing the prediction accuracy may help manage loss rates through the reduction of mispredictions (false positive and false negatives) as well as reduction of the number of transactions that fail to meet merchant quality of service parameters.

A successful prediction can be defined as a prediction that the likelihood of a particular transaction will be successful given a particular set of transaction attributes. Examples of these attributes are discussed below in the context of various machine-learning models that may be used in performing the prediction process. In particular, a classification model can be established and use the algorithms as classifiers. Some of the machine-learning algorithms that may be used include logical regression, Random Forest model, and Bayes, among others. This disclosure is not limited to these types of models; any suitable techniques may be employed.

Note that in many instances, the verification process may complete in a timely fashion and thus obviate the need for relying on the prediction process. The prediction process may thus be invoked based on a specified timeout, which may correspond to a quality of service parameter for a user. When a transaction request is received, the verification process may begin determining whether the transaction is to be approved or denied. If the verification process completes prior to the timeout, the results thereof (e.g., transaction approved or denied) may be provided, meaning that the prediction process is either not initiated or its results are discarded. On the other hand, if the verification process is approaching or exceeds a timeout threshold, the prediction process may be initiated such that a determination of pre-approval can be made within the specified time. In this manner, the prediction process, if invoked, can provide a prediction in a timely manner in accordance with the desired quality of service parameter.

In some embodiments, the prediction process is based on a loss budget, which indicates, in the context of a payment system, an amount of loss a service provider is willing to accept during a given time period for transactions that are pre-approved but are ultimately determined to fail by the verification process (e.g., because of fraud or insufficient funds). In cases in which the verification process fails subsequent to a prediction that results in pre-approval, the loss budget account may be debited for the amount of the transaction. If the loss budget becomes depleted or runs low, the prediction process may be inhibited until such time as the loss budget account is replenished, such as by the passage of time. In some cases, when transaction requests occur when the loss budget is depleted, the normal verification process is performed to determine whether a transaction is approved or denied without the prediction process being run to determine pre-approval. The prediction process may still be invoked in these instances, but may fail automatically based on the loss budget currently being exceeded. It is noted that the loss budget may be one of a number of loss budgets, with each of the loss budgets corresponding to, e.g., a particular merchant or other party that utilizes the transaction processing system.

The processing of some transactions may take into account the mechanism by which the transaction was initiated. Some transactions may be initiated by users having an account with a payment service provider. User metadata associated with the account, including transaction history, may be factored into determining if a transaction is eligible for pre-approval. Other transactions may be initiated by a user using a financial instrument (e.g., a credit card) wherein the user may not have an account with the payment service provider. In these transactions, user metadata may not be factored into the prediction process.

The various methods of conditional transaction pre-approval disclosed herein may be implemented on one or more computer systems. In one embodiment, a first computer system may process transactions without using user metadata, while a second computer system processes transactions using user metadata. As one example, the first computer system may receive transaction requests from merchants and perform transaction processing that does not take into account any user metadata associated with an account of a payment service provider, while the second computer system may receive transaction requests from the first computer system and continue transaction processing using metadata associated with an account of the payment service. In some implementations of this type of architecture, the prediction process may be divided between the computer systems. For example, the first computer system may execute a first set of routines to determine eligibility for the prediction process, while the second computer system may execute a second set of routines to perform the actual prediction for eligible transaction requests. Embodiments in which a single computer system executes both the first and second set of routines, as well as those in which the two computer systems exist but only one computer system is responsible for the prediction process, are also possible and contemplated. These and other embodiments are now discussed in further detail with reference to the drawings.

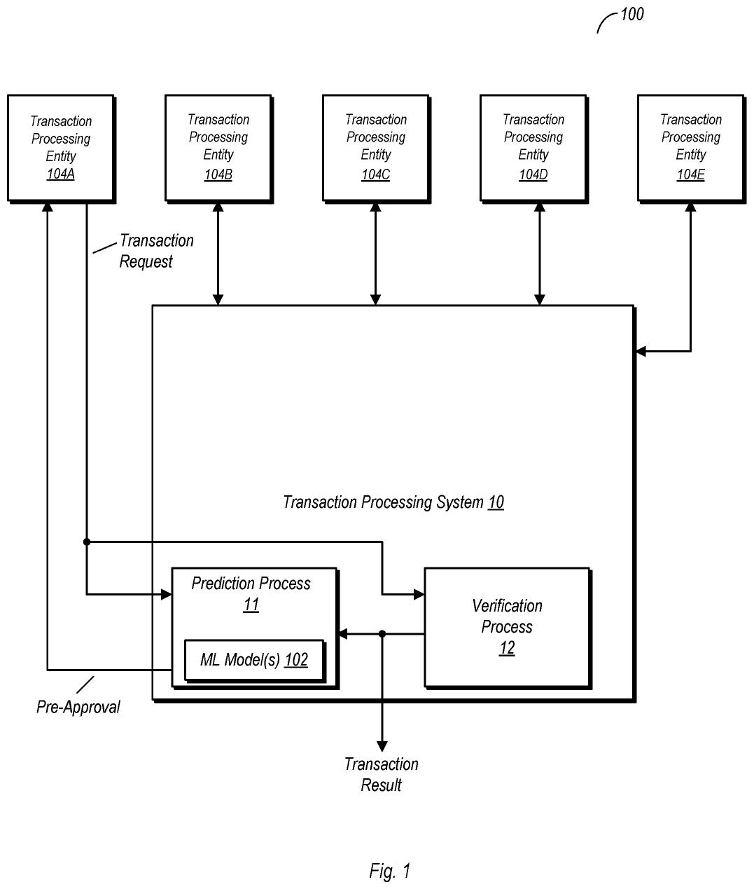

FIG. 1 is a block diagram of one embodiment of a transaction processing system. In the embodiment shown, transaction processing system 10 includes at least one computer system and implements a prediction process 11 and a verification process 12. Included within the prediction process 11 is one or more machine-learning models 102. The transaction processing system 10 in the embodiment shown is coupled to a number of transaction processing entities 104A-104E. These transaction processing entities may be part of other systems, such as those implemented by a merchant, to interface with transaction processing system 10. Transaction processing entities 104A-104E may also include, e.g., financial institutions associated with merchants, consumers, and/or any other parties involved in transactions conducted through transaction processing system 10.

Transaction processing systems may allow, for example, a consumer and a merchant to quickly and securely exchange funds to complete a transaction (e.g., a purchase of goods or services by the consumer from the merchant). Transaction processing system 10 is configured to perform a verification process 12 to determine whether a particular transaction corresponding to a transaction request should be approved—for example, in the context of a payment request, a detailed set of procedures may be implemented, including calls to payment processors external to system 10, to determine whether the payment is to be approved. Because an entity operating a transaction processing system for payments is typically financially liable for verified or approved transactions, verification process 12 serves an important role to help minimize situations in which transactions are approved but are ultimately found to be problematic (e.g., fraud is involved and the transaction is not settled properly).

But fully implementing verification process 12 for all transactions may often be costly from a time perspective, particularly in scenarios in which system 10 has a quality of service parameter established with one or more transaction processing entities 104. For example, there may be an average latency parameter established for a particular merchant, meaning that the average time it takes to process all transaction within some time period (e.g., a month) for that merchant should meet or fall below the time threshold established by this average latency value. In some cases, an entity operating system 10 may have to refund money to a transaction processing entity when a quality of service parameter is not met (e.g., in accordance with an SLA). Note that “quality of service parameter” as used herein refers broadly to any objective metric relating to how transaction processing requests are fulfilled, particularly timing metrics.

It has been recognized that it may be beneficial, under certain conditions to “pre-approve” certain transactions, meaning that, from the perspective of the transaction processing entities 104, the transaction is considered approved even though verification process 12 has not yet completed. Accordingly, prediction process 11 is used to predict whether or not the transaction will pass verification process 12. Prediction process 11, when utilized, makes predictions for particular transactions, such as by using machine-learning models 102. In some cases, the model used may be specific to one of the parties involved in the transaction (e.g., a merchant). In many cases, prediction process 11 may be performed only when it is determined that verification process is likely not going to complete for a particular transaction in a manner that satisfies a specified quality of service parameter. Thus, in some cases, prediction process 11 (or a portion of process 11) may be initiated only if a timeout is reached for a particular transaction. When a pre-approval is provided to a transaction entity (104A in this particular example), and eventually, the merchant, the transaction is effectively complete (or successful) from their perspective. For example, funds may be transferred for a pre-approved transaction as if the full verification process 12 had completed, even though it had not completed at the time of issuance of the pre-approval. Performing prediction process 11 in an effective manner thus allows transaction processing system 10 to improve the quality of service provided to transaction processing entities 104 by pre-approving those transactions under the condition that they have the indicia of a transaction that will ultimately be approved by verification process 12, but without having to actually complete that full verification process.

The verification process 12 as implemented here performs the actual verification of a transaction to determine whether the transaction should be approved or denied. When prediction process 11 is executed and renders a decision on pre-approval, the results of verification process 12 may be provided to the prediction process 11 to allow comparison of the predicted outcome of the transaction with the actual verification results. Such a comparison allows updating of a particular one of models 102 that was used in making the prediction. The updated one of models 102 may then be used for pre-approval of future transaction requests involving the party with whom that particular model is associated.

In sum, the use of prediction process 11 and the issuance of pre-approval decisions may allow a payment service provider to meet quality of service agreements with merchants with whom such agreements are active. For example, a ride-sharing service may have agreements with a payment service provider that operates transaction processing system 10 stipulating that transaction requests sent to the latter be approved or denied within a specified time limit (e.g., 2.5 seconds). If verification process 12 for some reason cannot approve or decline a particular transaction within this time, prediction process 11 may be used to determine whether the transaction can be pre-approved. Thus, a user of the ride-sharing service and the service itself may receive a decision regarding the transaction request within the specified time limit, and a fund transfer is authorized based on the pre-approval. Should prediction process 11 make an erroneous prediction that results in a pre-approval (as determined by verification process 12), the payment service provider assumes liability for the loss.

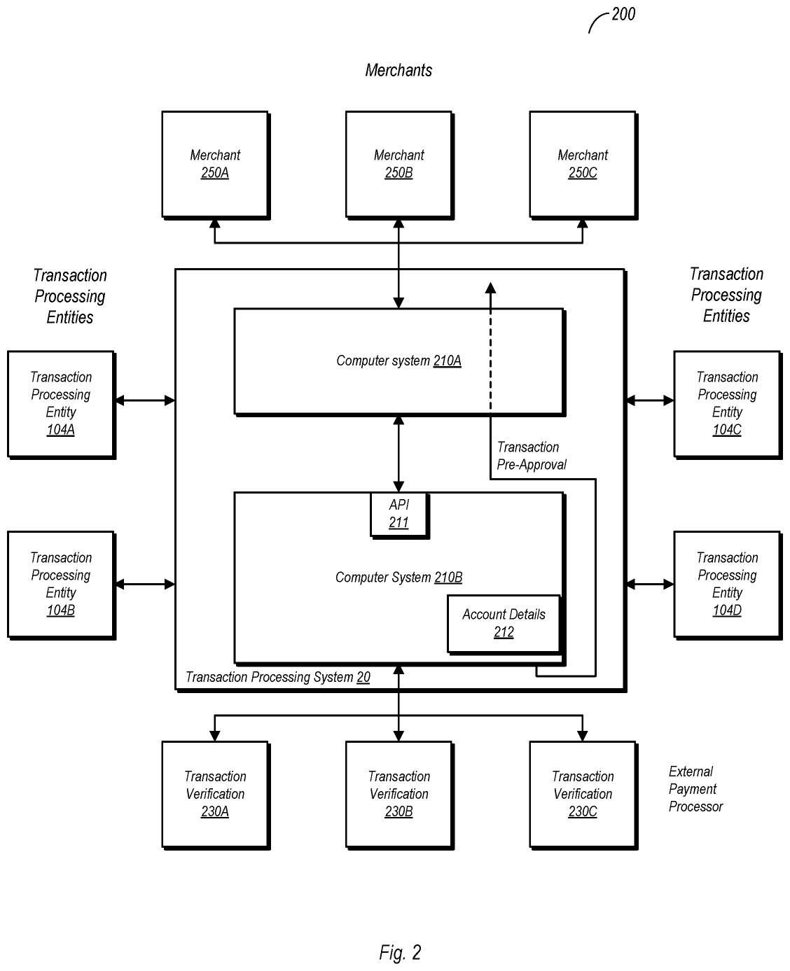

FIG. 2 is a block diagram illustrating an embodiment of a system 200 that includes transaction processing system 20 (which may be interchangeable with transaction processing system 10 of FIG. 1). In this particular embodiment, transaction processing system 20 includes two computer systems, computer system 210A and computer system 210B. These two computer systems may be used in combination to process transactions, including performing a prediction process as discussed herein. Communications between computer system 210A and 210B may be routed through an application programming interface (API) 211 implemented in computer system 210B. Although not explicitly shown here, one or both of computer systems 210A and 210B may perform a prediction for transaction processing using a machine-learning model. As will be described below, prediction process 11 may be implemented differently in various embodiments by distributing its functionality across the distinct computer systems of FIG. 2 in different architectures.

While transaction processing system 20 may process any suitable type of transaction, system 200 implements a network coupling entities to transaction processing system 20 to facilitate operations of a payment service provider. As shown, transaction processing system 20 is coupled to a variety of transaction processing entities, similar to FIG. 1. These entities include transaction processing entities 104A-D, as well as specific entities such as various merchants 250A-C that can initiate a payment request and transaction verification entities 230A-C that are configured to ultimately approve or deny a transaction. Transaction processing entities 104A-104D may be any of various other types of entities involved in the payment process, including a token service provider, merchant bank, issuer bank, etc.

In some embodiments, the prediction process is subdivided between computer system 210A and 210B. For example, in some cases, computer system 210A may perform a first part of the prediction process that includes an eligibility determination. The eligibility determination may be used to determine if a particular transaction request is eligible for pre-approval. When a transaction is eligible for pre-approval, the prediction process may be completed if the verification process consumes more than a specified time. If a given transaction is determined as not being eligible for the pre-approval process, the prediction process is typically not performed (or the pre-approval automatically fails), and the approval or denial of the transaction will be based on the normal verification process (with the possibility that the time to complete the transaction may exceed the specified time and thus negatively affect the quality of service for a particular user of system 200).

In some embodiments, computer systems 210 both perform payment processing functions for a payment request, but have different types of information available to them. For example, in one embodiment, computer system 210A may receive payment requests from merchants 250 and perform certain payment processing functions without the use of user metadata of a payment service provider, while transaction processing conducted on computer system 210B utilizes user metadata associated with accounts of a payment service. Consider an example in which computer system 210A corresponds to a platform that implements functionality of a BRAINTREE payment service provider, while computer system 210B corresponds to another platform that implements functionality of the PAYPAL payment service provider. In one scenario in which the two platforms are coupled together, processing at system 210A does not utilize metadata stored on system 210B about users of PAYPAL, which may include, for example, historical data about user transactions. The user metadata of system 210B (e.g., account details 212) corresponds to users having an account with the payment service provider. Note that some transactions originating from merchants may correspond to users who do not have an account with the payment service provider; accordingly, user metadata is not always applicable/present. Transactions initiated through interfaces of the payment service provider (e.g., smartphone apps, web interfaces) by account holders may therefore typically utilize account details 212. On the other hand, transactions initiated from accounts outside the umbrella of the payment service provider (e.g., using a credit card, debit card, or other instrument) are typically conducted without the use of account details 212.

Under one architectural approach, when a transaction request is received by transaction processing system 20, computer system 210A may initiate performing the eligibility determination for that request. The transaction request may also be conveyed through transaction processing system 20 to one of the transaction verification entities 230A-230C, which is commenced in parallel. If, after a specified amount of time, a verification result has not been returned, computer system 210B may initiate or complete the prediction process if the transaction has been indicated as eligible for pre-approval by computer system 210A. For example, suppose a quality of service parameter for a particular merchant is 1 second. Thus, if a verification result is not returned by some internal time threshold (e.g., 800 ms), the prediction process may be initiated or continued so that the result is available prior to the 1 second timeout. (This 200 ms “lead time” is used in order to give the prediction process the necessary time to complete.) If the transaction is not predicted to be approved, no pre-approval indication is issued, and instead, the verification result governs transaction approval or decline.

While the embodiment of FIG. 2 is discussed as subdividing the eligibility and prediction processes between the two illustrated computer systems, it is noted that transaction processing system 20 is not limited in this manner. In various embodiments, a transaction processing system according to this disclosure may have different subsystems, and/or the prediction process may be distributed differently than described here. For example, it is possible that some merchants are coupled to the combination of computer systems 210A and 210B, other merchants are coupled directly to computer system 210B, and thus the prediction process may operate in accordance with this coupling.

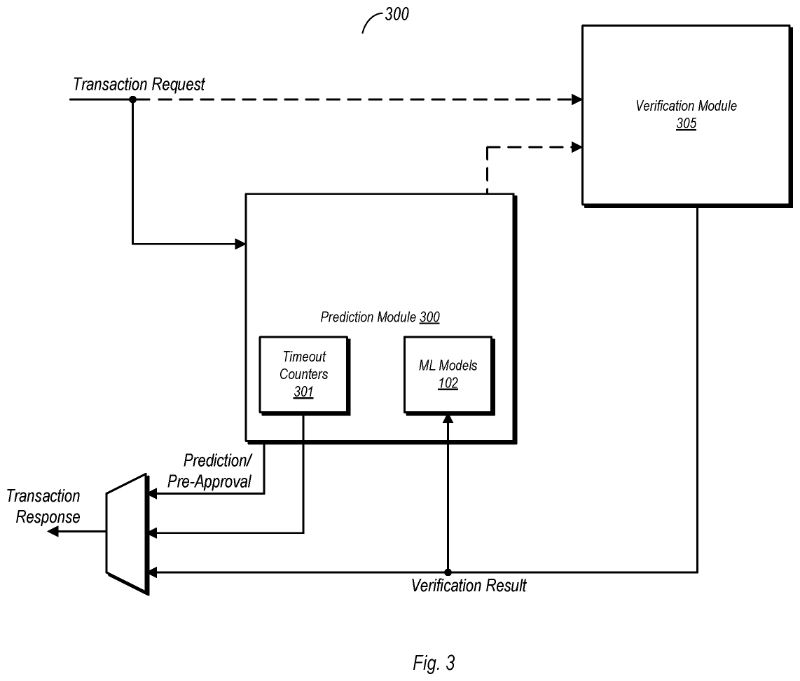

FIG. 3 is a block diagram illustrating various components of a transaction processing system 300. In particular, FIG. 3 illustrates the arrangement of a prediction module 300 and a verification module 305, which may be distributed in various manners within a transaction processing system such as system 10 or 20. Prediction module 300 in this embodiment implements prediction process 11 and includes timeout counter 301 and machine-learning models 102. For particular transactions, timeout counter 301 may be set to a value that is specific to, e.g., particular merchants or other tenants having quality of service agreements with the payment service provider operating the system. Similarly, the machine-learning models 102 may also be specific to particular merchants, especially since different merchants may benefit from different types of machine-learning models.

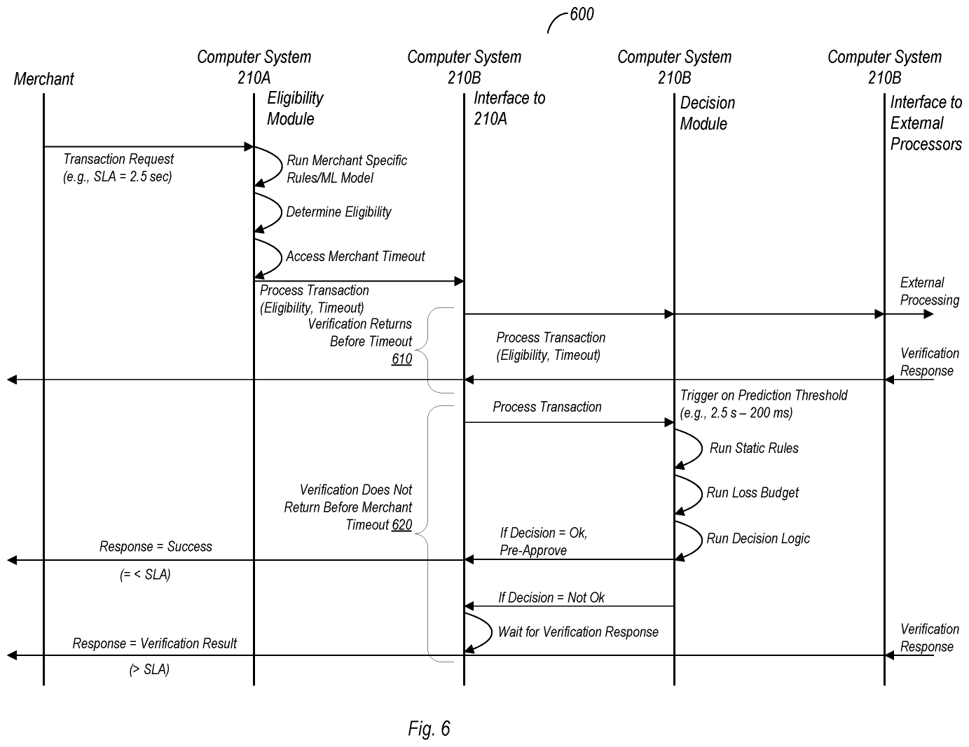

In the embodiment shown, an incoming transaction request may be received by both the prediction module 300 and verification module 305. Alternatively, an incoming transaction request can be received by prediction module 300 and be forwarded to verification module 305. Upon receiving the incoming transaction request, the verification module may initiate the verification process. Similarly, the prediction module 300 may also, at least in some embodiments, begin executing routines to determine if the requested transaction is eligible for pre-approval. Furthermore, counter 301 may begin to track the time elapsed from initial receipt of the transaction request. Various other counters are also contemplated in different embodiments, such as those discussed with reference to FIGS. 6-9. If the verification module completes the verification prior to a quality of service timeout duration (e.g., 1 second, per the example given above) specified by the corresponding one of timeout counters 301, the verification result (e.g., transaction approved or declined) will typically be issued as the transaction response, irrespective of whether any pre-approval has been successfully indicated.

In addition to tracking the amount of time a given transaction has been pending relative to a quality of service threshold, timeout counter 301 may also be used to determine when the merchant timeout threshold is approaching (this “offset” is referred to herein as the prediction timeout threshold). If the specified prediction timeout threshold is reached prior to receiving a verification result from verification module 305, prediction module 300 may begin execution of a prediction process to determine if the transaction is to be pre-approved (assuming the transaction is eligible for pre-approval). If the prediction module 300 predicts that verification module 305 will approve the transaction and it is determined that the verification result has not been provided by the prediction timeout threshold, the prediction process can be initiated or completed to determine if pre-approval is indicated. In such a case, the pre-approval may be provided as the transaction response. In one embodiment, if prediction module 300 predicts that the transaction will be declined by verification module 305, no indication is provided. Instead, the transaction response can be determined by the outcome of the verification process. In other embodiments, the output of the prediction process may actually used as the final determination, thus overriding the verification process. Such a result may be appropriate when sufficient information is available to the prediction process (e.g., user metadata of a payment service), such that a transaction approval or decline can be predicted with confidence. In many cases, the eventual verification result output by verification module 305 is provided to prediction module 300 to update a corresponding one of machine-learning models 102 (e.g., the particular model is associated with a particular merchant). By updating the machine-learning modules, the ability of prediction module 300 to correctly predict future transactions may be enhanced.

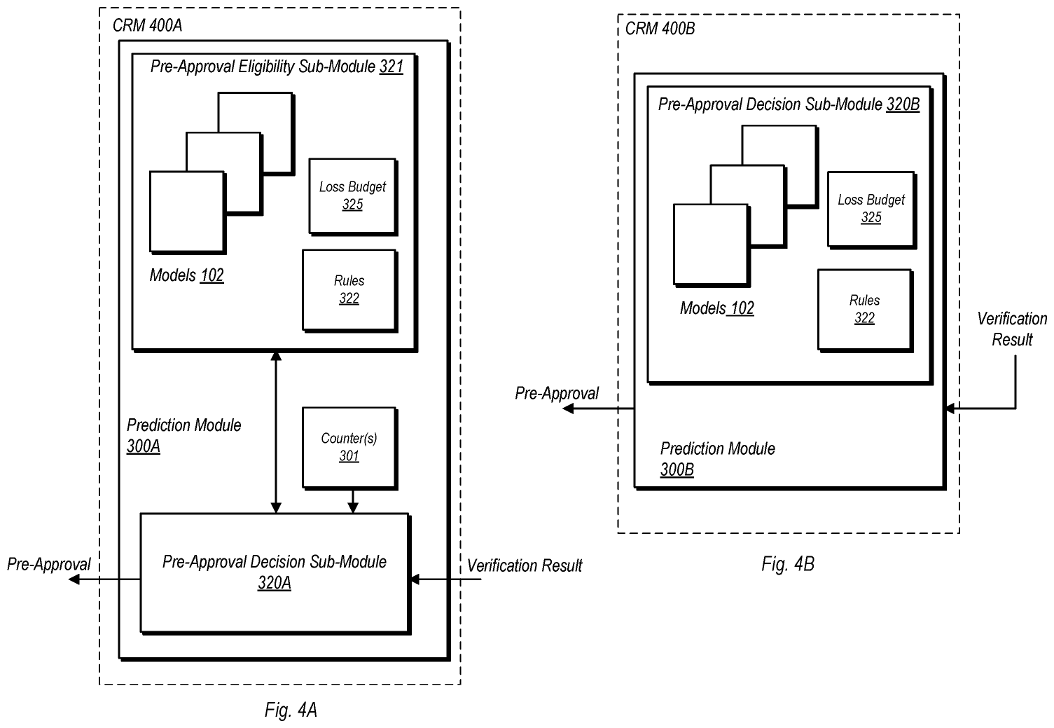

FIGS. 4A and 4B are block diagrams illustrating respective embodiments of a prediction module used in various embodiments of a transaction processing system. FIG. 4A is directed to an embodiment of a prediction module that includes a pre-approval eligibility sub-module and a pre-approval decision sub-module. FIG. 4B is directed to an embodiment that includes a pre-approval decision sub-module.

In FIG. 4A, an embodiment of a prediction module 300A is illustrated. As used herein, the term “module” refers to circuitry configured to perform specified operations or to physical non-transitory computer readable media that store information (e.g., program instructions) that instructs other circuitry (e.g., a processor) to perform specified operations. Modules may be implemented in multiple ways, including as a hardwired circuit or as a memory having program instructions stored therein that are executable by one or more processors to perform the operations. A hardware circuit may include, for example, custom very-large-scale integration (VLSI) circuits or gate arrays, off-the-shelf semiconductors such as logic chips, transistors, or other discrete components. A module may also be implemented in programmable hardware devices such as field programmable gate arrays, programmable array logic, programmable logic devices, or the like. A module may also be any suitable form of non-transitory computer readable media storing program instructions executable to perform specified operations. In FIG. 4A, prediction module 300A is illustrated as being implemented on a computer readable medium (CRM) 400A. CRM 400A may be any type of non-transitory computer readable medium, including (but not limited to) disk storage, flash memory, various types of programmable read only memory, and so on. Similarly, prediction module 300B of FIG. 4B is shown as being implemented on CRM 400B, which is also a non-transitory computer readable medium that may be any of the same types as CRM 400A.

Prediction module 300A in the embodiment shown has two sub-modules: a pre-approval eligibility sub-module 321 and a pre-approval decision sub-module 320A. Pre-approval eligibility sub-module 321 in the embodiment shown uses a number of different models 102, as described above. Pre-approval eligibility sub-module 321 may also implement a number of static rules 322 that apply to all transactions, in some embodiments. Various ones of static rules 322 may include (but are not limited to) particular credit card numbers (e.g., credit cards associated with negative transaction outcomes), blacklisted customers, a listing of similar transactions that were determined as fraudulent, a listing of merchants associated with negative transaction outcomes, and so on. These rules can be accessed when pre-approval eligibility sub-module 321 is determining the pre-approval eligibility for a requested transaction. In some cases, the use of these rules may accelerate the determination of eligibility. For example, if a transaction request is associated with a blacklisted customer, the transaction can be deemed ineligible for pre-approval irrespective of other factors.

Models 102 in the embodiment shown are machine learning models. A machine learning model may be a mathematical representation of a process, such as the verification process discussed herein. The model is initially developed using training data. For example, historical transaction data (e.g., transactions that approved/disapproved) may be used in initially developing the model. The types of data may be used in developing the initial model, updating the model with subsequent transactions, and utilizing the model when predictions are made include transactions amounts, risk scores, currency used, financial instruments used or attempted, merchant product type, merchant payment schedule, buyer and/or seller countries, account numbers, billing agreements, and so forth. Generally speaking, any type of information that may be useful in making accurate predictions may be used for the model. Various machine learning model types that may be used to implement models 102 includes logistical regression, Bayesian and Random Forest, although the disclosure is not limited to these types. A corresponding one of models 102 may be accessed in determining the eligibility of a requested transaction for pre-approval. As discussed elsewhere herein, these models may be specific to, e.g., particular merchants, with different models for different merchants. The various ones of models 102 may include various factors that a merchant would request to be considered when making an approval or decline of a particular transaction (e.g., transaction amounts, transaction frequency, etc.).

Additionally, these models may be updated for each transaction request for which a decision is reached. In this way, each of the models 102 provides transaction history that is used by pre-approval eligibility sub-module 321 when determining pre-approval eligibility. When pre-approval eligibility sub-module 321 determines that a transaction is eligible for pre-approval, an indication is provided to pre-approval decision sub-module 320A.

In some embodiments, loss budget 325 may also be factored into the determination of pre-approval eligibility in the context of payment systems. As used herein, a “loss budget” refers to a value that corresponds to or is indicative of an amount of loss that an entity such as a payment service provider is willing to bear during a specified time period for mispredicted transactions. In some instances, a loss budget may correspond to a specified amount of a particular currency. The loss budget is used to keep track of pre-approved transactions that are incorrectly predicted (particularly, the amount of currency for these transactions), and may thus influence future pre-approval predictions. When a misprediction occurs, the loss budget may be debited or decreased. When depleted, the loss budget may render subsequent transaction requests ineligible for pre-approval, irrespective of other factors. The loss budget may be periodically replenished (e.g., on a daily or weekly basis). As with models 102, loss budgets may be specific to particular merchants and/or tenants. As used herein, the term “tenant” in this disclosure is used to refer to tenants of a payment services provider (e.g., VENMO may be a tenant of PAYPAL when the latter acts as a payment services provider), as well as to different issuer financial institutions.

Whereas pre-approval eligibility sub-module 321 may begin execution upon receiving a transaction request in some embodiments, pre-approval decision sub-module 320A may execute conditionally in some instances. In the embodiment shown in FIG. 4A, execution of the prediction/pre-approval decision module 320A may occur in response to receiving an indication that the requested transaction is eligible for pre-approval (per sub-module 321), and an indication from a corresponding one of counters 301 that a prediction threshold has been reached. One merchant may have a quality of service parameter indicating a desired average latency of 2.5 s, while another merchant might have a desired average latency of 1 s. These values are examples of a merchant timeout threshold. A prediction threshold is some time value in advance of the merchant timeout by which the prediction process should be commenced in order to deliver a pre-approval determination in time to meet the merchant timeout threshold.

For example, if it might take the prediction process up to 200 ms to generate a pre-approval prediction, the prediction threshold would be 2.3 s and 0.8 s for these two examples. When both an indication of pre-approval eligibility and an indication that the prediction threshold has been reached are received by pre-approval decision sub-module 320A, a prediction process begun by pre-approval eligibility sub-module 321 is completed by pre-approval decision sub-module 320A. If sub-module 320A predicts that requested transaction will be approved by verification process 12, pre-approval decision sub-module 320A may issue a pre-approval indication. The issuance of the pre-approval indication occurs when it is determined that the verification result will not be provided in time to meet desired quality of service. If the prediction process completed by sub-module 320A does not result in pre-approval, no indication is provided, and the result of verification process 12 will thus govern whether the transaction is approved. As previously mentioned, generally speaking, from the standpoint of the initiator of the transaction, the pre-approval indication effectively acts as an approval of the transaction in that payment is effectuated, regardless of the eventual result of verification process 12.

After the actual verification result is received, pre-approval decision sub-module 320A may compare the prediction with the actual verification result to determine if the prediction was correct. The comparison information may be forwarded to update the appropriate one of models 102, thereby embedding history of that transaction into the model for future predictions.

FIG. 4A illustrates an embodiment in which the functionality of prediction process 11 is distributed between two sub-modules. In the embodiment shown, prediction module 300A is implemented on a non-transitory computer readable medium 400A, which may be any type of medium (e.g., flash memory, disk storage) that provides persistent storage of information. In alternate embodiments, sub-modules 321 and 320A of prediction module 300A might be implemented on different computer systems, such as computer systems 210A and 210B in FIG. 2. FIG. 4B illustrates an embodiment in which the functionality of prediction process 11 is found in a single module, and is implemented on a non-transitory computer readable medium 400B. This paradigm may be implemented in a scenario in which there are not distinct computer systems 210A and 210B as in FIG. 2. Alternately, this paradigm may be implemented even when the functionality of a transaction processing system is split between computer systems such as 210A and 210B. For example, module 320B might be implemented solely within computer system 210B, meaning that prediction process 11 might only occur within computer system 210B (e.g., PAYPAL) even in an architecture in which system 210B receives payment requests from system 210A (e.g., BRAINTREE).

As illustrated, prediction module 300B does not include the pre-approval eligibility sub-module. Instead, models 102, rules 322, and loss budget 325 are all implemented in pre-approval decision sub-module 320B. In this embodiment, there is no separate eligibility determination. For embodiments in which a separate eligibility determination is made, FIG. 4A applies.

It is additionally noted that, while no counter is shown in the embodiment of FIG. 4B, one may nevertheless be present therein, arranged similarly to the embodiment of FIG. 4A. In other embodiments, a counter may be implemented external to prediction module 300B.

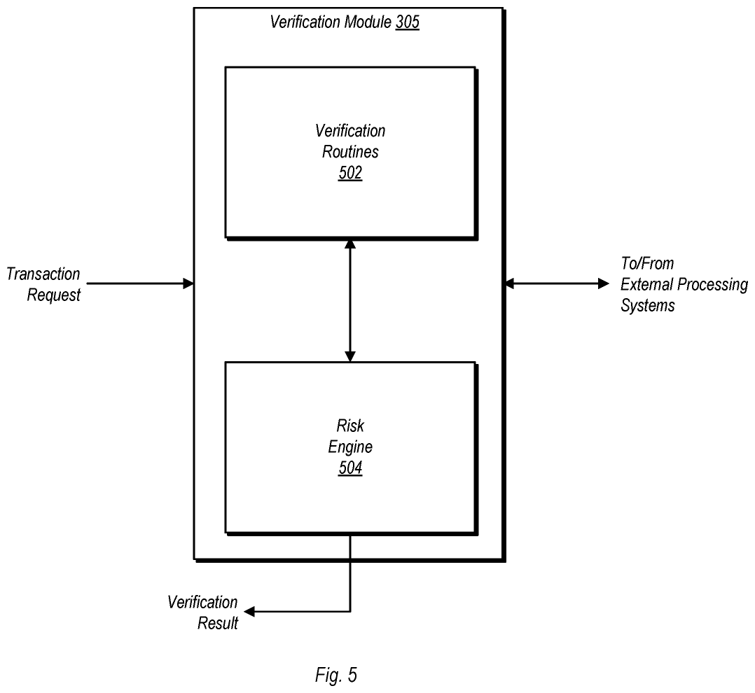

FIG. 5 is a block diagram illustrating one embodiment of a verification module used in various embodiment of a transaction processing system. In the embodiment shown, verification module 305 performs verification routines that determine whether a transaction is to be approved or denied. Execution of these routines may be initiated responsive to receiving an incoming transaction request. In some embodiments, prediction process 11 and verification process 12 may be commenced concurrently with the receipt of a transaction request. In the case where no prediction is made (either because there is no eligibility or because the prediction process ultimately does not predict pre-approval), the verification result typically controls whether a given transaction is approved or declined. Accordingly, the verification result indicates whether the transaction would have been approved or declined absent the prediction. In some embodiments, when a given transaction is predicted to be declined, the system will wait for a result of verification process 12, which may in some cases override the result of prediction process 11. In general, the verification process 12 performed by verification module 305 will govern approval or denial of a transaction request. But if the verification process 12 takes too long, a positive pre-approval decision may be issued if prediction process 11 so indicates. In various embodiments, when verification process 12 implemented by verification module 305 does actually complete for a particular transaction, the verification result is provided to a prediction module in order to update and refine the model(s) upon which the prediction was based.

Verification module 305 in the embodiment shown includes a verification routines module 502 and a risk engine 504. These are exemplary routines; verification module may include any suitable verification technique. Verification module 305 may include program instructions executable to contact external payment processors that make a final determination as to a particular transaction. Verification routines may vary from one merchant/tenant to another in some embodiments. The verification routines may access information related to the source of the transaction request, the party or parties making the request, transaction history, and any other relevant information during their execution.

Risk engine 504 may perform risk analysis on a particular transaction request. The risk analysis may also factor in transaction history, as well as other information such as transaction amount, any available details regarding the requestor of the transaction, and so forth. Various risk rules may also be applied to determine if, e.g., the requested transaction represents unusual transaction behavior by the requestor or any other unusual details regarding the transaction. Risk engine 504 may utilize metadata from a user account of a payment service provider such as PAYPAL in some embodiments.

Based on the execution of verification routines 502 and analysis performed by risk engine 504, verification module 305 outputs a verification result. If the verification result is provided prior to the time specified by a corresponding quality of service parameter, the verification result will in many cases govern whether the transaction is approved or declined, irrespective of any prediction that has been made. If the quality of service time has elapsed, and a prediction for the transaction did not result in pre-approval, the system then waits for the verification result, which can result in approval or denial of the transaction. The verification result may also be provided to a prediction module as described above for the purposes of updating the machine learning models.

FIG. 6 is a diagram depicting a sequence 600 that illustrates various operations that are performed in the context of a transaction processing system that uses computer systems 210A and 210B to conduct a merchant-initiated transaction. As depicted in FIG. 6, prediction process 11 in this architecture is distributed between computer systems 210, with system 210A performing an eligibility determination (e.g., using pre-approval eligibility sub-module 21), and system 210B performing a pre-approval determination (e.g., using pre-approval decision sub-module 320A). One example of a configuration in which this architecture could be deployed is the BRAINTREE platform coupled to the PAYPAL platform. In sequence 600, however, transactions are processed without reference to any user account metadata of a payment service such as PAYPAL. Accordingly, the transactions of sequence 600 may be considered an “unbranded” transaction in that they are not being processed using user account information stored by or accessible to computer system 210B. Examples of these unbranded transaction include scenarios in which a merchant receives a payment request based on a credit or debit card, and that request is not linked to an account of a payment service. Accordingly, the transaction is processed by computer systems 210A and 210B based on the details of the payment instrument and not any user account metadata of system 210B.

Sequence 600 begins with the conveying of a transaction request to computer system 210A, with an SLA specifying a desired latency of 2.5 seconds or less. Upon receiving the transaction request, an eligibility module in computer system 210A performs a first portion of prediction process 11 by running merchant-specific rules and a machine learning model (that is specific to the particular merchant) and determining if the transaction is eligible to be considered for pre-approval. Additionally, the decision module in computer system 210A accesses merchant timeout information that corresponds to a quality of service threshold for that merchant. In the example shown in FIG. 6, the merchant timeout is 2.5 seconds. This represents a desired amount of time by which a verification result (approval/denial) is to be returned to the merchant (this value is typically established in an agreement with the payment service provider). This eligibility determination and the merchant timeout are then passed to an interface of computer system 210B.

Computer system 210B then passes this inbound information to both a decision module as well as to an outbound interface from which the transaction request is conveyed for external processing that determines verification, such as calls to external processors. There are multiple paths that are depicted for possible next steps. Reference numeral 610 indicates a path in which the verification response is returned prior to the merchant timeout. In this scenario, the result of the verification response (either approve or deny) is passed through computer system 210A and back to the merchant. In this case, the verification result is the final result of the transaction.

As shown, computer system 210B passes the eligibility determination from system 210A and the merchant timeout (e.g., 2.5 seconds) to a decision module, which may correspond to sub-module 320A of FIG. 4A. This module will trigger when a counter that is used to monitor the verification latency approaches the specified merchant timeout. The decision module will take some maximum amount of time to run, and in order to meet the merchant timeout in terms of returning a verification response or a pre-approval, decision module will need to start running at some offset prior to the merchant timeout. As noted above, this time is referred to as the prediction threshold. Consider an implementation in which once the decision module is triggered, it will take up to 200 ms to execute the decision module and return a pre-approval determination to the merchant. In this scenario, the offset is 200 ms, or 0.2 s, while the prediction threshold is 2.3 seconds, or 2.5 s-0.2 s. Accordingly, if a verification result has not been returned by the prediction threshold of 2.3 seconds, the decision module will be triggered at that time. The decision module can thus be said to be triggered as the time taken to return the verification response “approaches” the merchant timeout, because when the time reaches the prediction threshold, it is at some offset less than the merchant timeout.

Sequence 600 illustrates that the decision module can operate on various criteria, including those similar to those that may be used by the eligibility module. These criteria include any merchant-specific rules, static rules (i.e., those applicable to all merchants), and the loss budget (either for the merchant or all transactions). Using this information, the decision logic is run to produce a decision result. Note that in many instances, if the eligibility parameter passed to computer system 210B by computer system 210A does not indicate eligibility, this criterion alone may cause the decision module to return a negative result relative to pre-approval.

Reference numeral 620 indicates the paths that may be taken if the verification does not return a response before the merchant timeout (e.g., 2.5 seconds). As described above, the decision module will have triggered at the prediction threshold (e.g., 2.3 seconds) if the verification response has not been returned. This means that the result of the decision module will be available as of the point the merchant timeout is reached.

As illustrated, this decision result is either Decision=Ok or Decision=Not Ok. When the decision module determines that Decision=Ok, this is an indication that the transaction is pre-approved. Accordingly, when the verification result is still not returned at the time of the merchant timeout, the pre-approval is transmitted to the merchant. From the merchant's perspective, the transaction is finalized (i.e., approved) upon receiving the pre-approval indication, meaning that the merchant will expect the transaction to be fulfilled.

If, on the other hand, the decision module determines that decision=Not Ok, a pre-approval determination is not transmitted to the merchant. Instead, the process waits for the verification response to be returned. This may result in the verification result not being received by the merchant until after the merchant timeout has been exceeded. Accordingly, in this embodiment, when the decision module indicates “Not Ok,” this does not mean the transaction will not ultimately be approved. This negative decision instead simply indicates that pre-approval will not be granted.

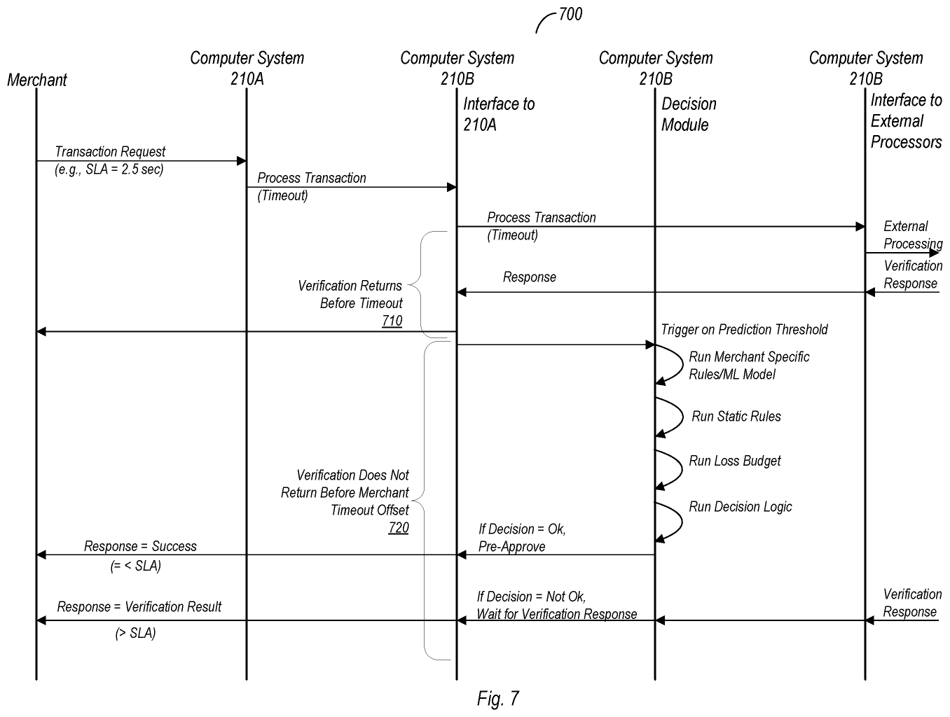

FIG. 7 depicts a sequence 700 that is similar in some respects to sequence 600. Like sequence 600, sequence 700 depicts processing of transactions in an architecture that includes computer system 210A and 210B. As with the transactions processed by sequence 600, those processed by sequence 700 are unbranded, meaning that they are not processed using user account information stored by or accessible to computer system 210B. But in contrast to sequence 600, which distributes prediction process 11 between computer systems 210A and 210B, prediction process 11 is implemented solely on computer system 210B in the architecture depicted by sequence 700. Accordingly, this paradigm is similar to that depicted in FIG. 4B, in contrast to sequence 600, which is similar to the paradigm of FIG. 4A. The flow of sequence 700 is thus similar to that of sequence 600, except that there is not a separate eligibility determination passed to a decision module. Instead, the decision module in computer system 210B fully implements prediction process 11. As in sequence 600, if the verification returns before the merchant timeout, that result is used. Otherwise, the decision module will trigger at the prediction threshold as the latency of the verification process is approaching the merchant timeout. If the decision module returns “Ok,” pre-approval is returned if the merchant timeout is not ultimately met. If the decision module returns “Not Ok,” then pre-approval is not returned and the process waits on the verification response to return, even if the merchant timeout is exceeded.

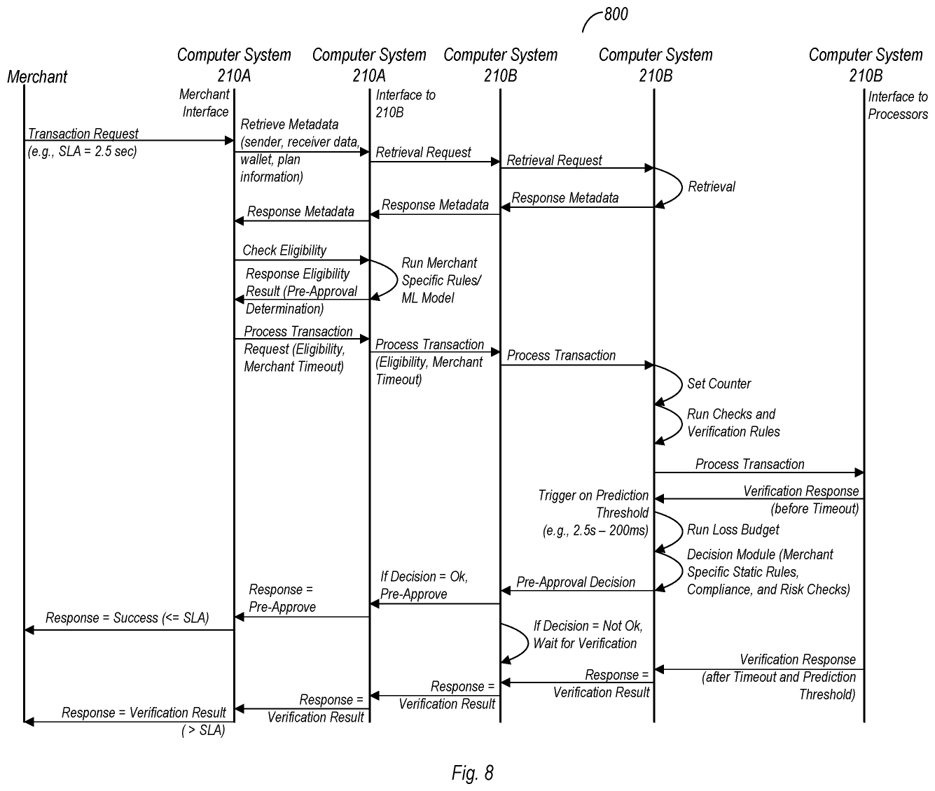

FIG. 8 is a diagram depicting a sequence 800 that illustrates various operations that are performed in the context of a transaction processing system that uses computer systems 210A and 210B to conduct a merchant-initiated transaction. In the embodiment shown, prediction process 11 as depicted in sequence diagram 800 distributes the process between computer systems 210A and 210B. In contrast to the sequences depicted in FIGS. 6 and 7, sequence 800 is shown here in the context of a transaction in which the user interacting with the merchant has an account with the payment service provider that operates computer systems 210A and 210B (so-called “branded” transactions). For example, if the payment service provider is PAYPAL, a user interacting with the merchant in sequence 800 may have an account with PAYPAL. Since the user has an account with PAYPAL, user metadata available to PAYPAL (and stored for example at computer system 210B) is accessed and factored into the determination whether or not to pre-approve the transaction.

Sequence 800 begins with the conveying of a transaction request to computer system 210A. As an example, the transaction may involve a merchant that has an SLA that specifies a 2.5 s response time for transactions. Upon receiving the transaction as computer system 210A, a call is made to computer system 210B, which requests metadata (this request may go through various modules in systems 210A and 210B). The metadata may include any of various types of information that may be maintained by a payment service provider, including information about a sender (e.g., a purchaser or consumer) and receiver (e.g., a merchant) associated with the transaction, wallet information (which may indicate the various payment instruments of the purchaser that are maintained by the payment service—e.g., PAYPAL WALLET), and other types of information such as transaction history for the user, account balances, and so on. Upon retrieval, the user metadata (‘Response Metadata’) is conveyed back to computer system 210A.

Upon receiving the user metadata, computer system 210A performs an eligibility check to determine whether to further consider the transaction for pre-approval. In FIG. 8, the eligibility check includes running merchant-specific rules in light of the request, which may include a machine-learning model for the merchant in some embodiments. Thereafter, a response eligibility result is returned, indicating whether the transaction is eligible for further consideration for pre-approval. Thereafter, the eligibility decision and the merchant timeout value are passed to computer system 210B. In computer system 210B, a counter is set and further checks and verification rules are run in light of the transaction request and the eligibility results. Computer system 210B then conveys a request for additional processing to external processors through an interface thereto. The verification response is then returned, although the sequence thereafter depends on whether the response is received before or after the merchant timeout.

Upon triggering of a prediction threshold (e.g., a merchant timeout minus a specified time needed to complete pre-approval), the sequence runs a loss budget check and a decision module that may include running merchant-specific static rules as well as various compliance and risk checks to obtain a pre-approval decision. If the decision=Ok, an indication of pre-approval is conveyed from computer system 210B, through computer system 210A to the merchant. This pre-approval indication is received by the merchant within the specified timeout.

In the case where the decision=Not Ok (e.g., transaction not pre-approved or eligible for pre-approval), the process waits for the verification response received from external processors. The result of the external processors thus becomes the transaction result. When the verification response is received by computer system 210B from the external processors, it is conveyed from computer system 210B to computer system 210A, and then on to the merchant. In some cases, the verification result that determines approval or denial of the transaction may be received after the merchant-specified timeout.

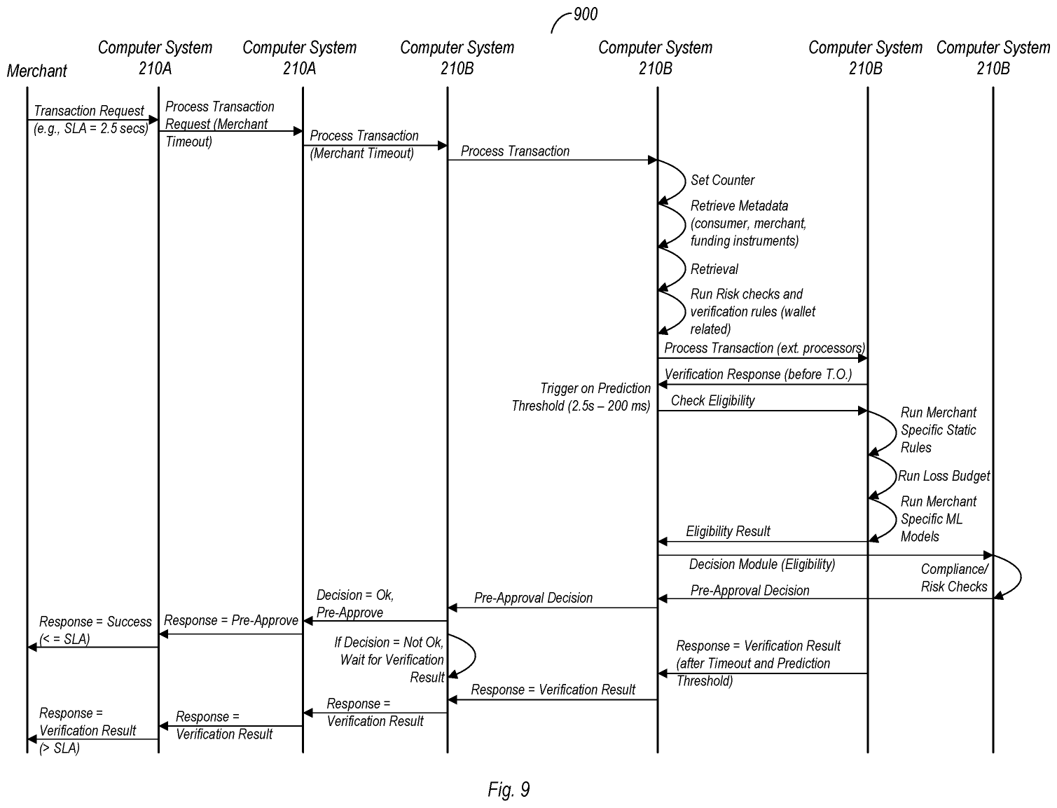

FIG. 9 is another diagram depicting a sequence in which the user is an account holder with a payment service provider such as PAYPAL. This is therefore another example of a “branded” transaction. In contrast to the various sequences depicted in FIGS. 6 and 8, but similar to the sequence depicted in FIG. 7, prediction process is conducted solely in computer system 210B. Thus, in this particular sequence, computer system 210A acts primarily as a gateway (e.g., an interface to the merchant).

Sequence 900 begins with the conveying of a transaction to computer system 210A, which in turn passes through various modules of system 210A and then to computer system 210B. In computer system 210B, the processing includes setting a counter, issuing a request to retrieve metadata (e.g., consumer information, merchant information, available funding instruments, such as that discussed above relative to FIG. 8), retrieving the metadata, and running risk checks and verification rules that are wallet related. Thereafter, a request to process the transaction is conveyed from computer system 210B to external processors with a verification response being returned.

If the prediction threshold (e.g., 200 ms before the SLA threshold) is reached, an eligibility check is performed. The eligibility check includes the running of merchant-specific static rules, a loss budget check and merchant-specific machine-learning models. The result of these checks produces an eligibility result which indicates whether the requested transaction is eligible for further consideration for pre-approval determination. For an eligible transaction, a call is made to a decision module, which runs compliance and risk checks to complete the prediction process. The product of the compliance and risk checks is a pre-approval decision, indicating whether the transaction is pre-approved. If the decision=Ok (transaction pre-approved), this indication is conveyed from computer system 210B to computer system 210A, and then on to the merchant. Receipt of the pre-approval decision results in a successful response within the time limits specified by the SLA between the payment service provider and the merchant.

In the case where the decision=Not Ok, the verification result ultimately governs whether the transaction is approved or denied. Upon receiving the verification result from external processors, the result is conveyed as the transaction response from computer system 210B, through computer system 210A, and then to the merchant. As with sequence 800 discussed above, in cases where no pre-approval is indicated, it is possible that the verification result arrives after the timeout specified by the SLA.

Although specific sequences have been illustrated in FIGS. 6-9, other sequences are contemplated. For example, in the context of the architecture in which prediction process 11 is distributed between computer systems 210A and 210B (as in FIGS. 6 and 8), the eligibility determination performed by computer system 210A may be ignored if it can be determined that pre-approval can instead be determined solely by computer system 210B—for example, when there is additional information on computer system 210B that is not provided to system 210A for its eligibility determination. This paradigm may be invoked in some cases when the amount of time the transaction has been pending reaches the prediction threshold, indicating that the merchant timeout is being approached. When the prediction threshold is reached in such an approach, the second portion of the prediction process is executed to determine whether to pre-approve the transaction irrespective of any results that may be been generated by execution of the first portion.

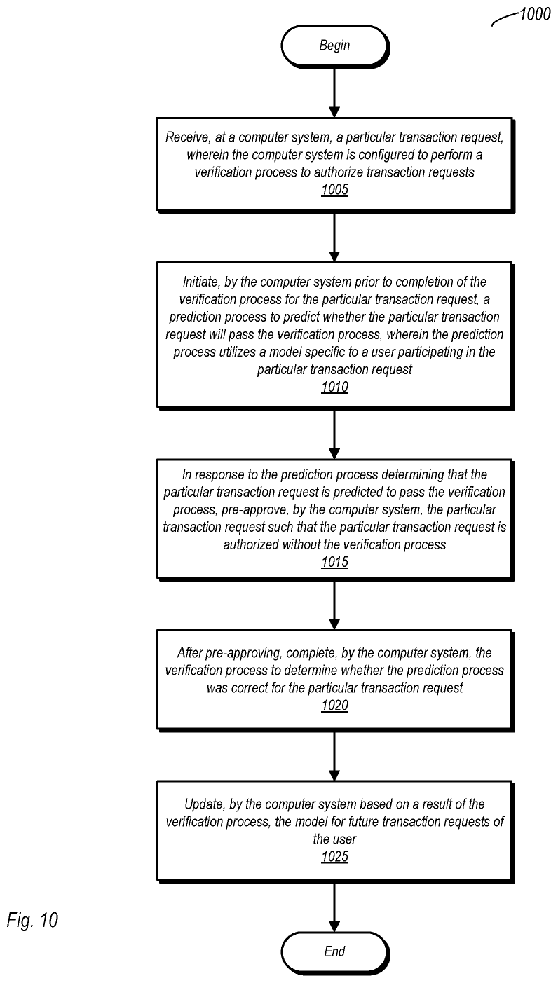

FIG. 10 is a flow diagram illustrating one embodiment of a method for conducting a transaction. Method 1000 as shown here may be performed with various embodiments of a transaction processing system as shown in the various drawings and discussed above in reference thereto. Other transaction processing systems not explicitly shown herein may also be capable of carrying out method 1000, and may thus fall within the scope of this disclosure.

Method 1000 begins with the receiving, at a computer system, a particular transaction request, wherein the computer system is configured to perform a verification process to authorize transaction requests (block 1005). The method further includes initiating, by the computer system prior to completion of the verification process for the particular transaction request, a prediction process to predict whether the particular transaction request will pass the verification process, wherein the prediction process utilizes a model specific to a user participating in the particular transaction request (block 1010). In response to the prediction process determining that the particular transaction request is predicted to pass the verification process, the method includes pre-approving, by the computer system, the particular transaction request such that the particular transaction request is authorized without the verification process (block 1015). The pre-approving may in some cases be based on a threshold timeout occurring. After the pre-approving, the method continues by completing, using the computer system, the verification process to determine whether the prediction process was correct for the particular transaction request (block 1020). The embodiment of method 1000 illustrated here concludes by updating, using the computer system based on a result of the verification process, the model for future transaction requests of the user (block 1025).

In one embodiment, the prediction process includes a first set of routines executable to determine eligibility for pre-approval of the particular transaction request, wherein the first set of routines is executed prior to beginning the verification process for the particular transaction request. The prediction process includes a second set of routines executable to determine, based on an outcome of the first set of routines, whether the particular transaction request is pre-approved. The verification process for the particular transaction request is begun after the first set of routines is complete and before the second set of routines is initiated. The second set of routines is executed in response to the first set of routines indicating eligibility for pre-approval and a duration of the verification process approaching a specified timeout threshold, wherein the timeout threshold corresponds to a quality of service parameter for the user. The first set of routines utilizes the model to determine eligibility for pre-approval.

In various embodiments, the prediction process further utilizes various criteria for making a pre-approval determination, including a set of static (i.e., non-merchant-specific) rules, a set of merchant-specific rules or models, and a transaction loss budget. As described, the transaction loss budget takes into account a merchant participating in the particular transaction request. The prediction process in some instances utilizes metadata associated with an account of a transaction service that corresponds to a user participating in the particular transaction request (e.g., account metadata for a PAYPAL user).

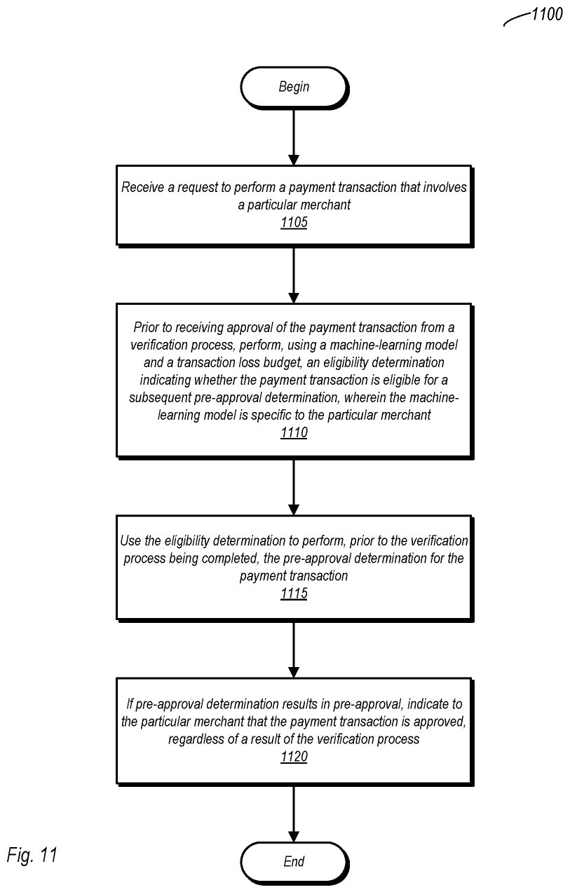

FIG. 11 is a flow diagram illustrating another embodiment of a method for conducting a transaction. As with the method illustrated in FIG. 10, method 1100 of FIG. 11 may be performed with various embodiments of a transaction processing system as shown in the various drawings and discussed above in reference thereto. Other transaction processing systems not explicitly shown herein may also be capable of carrying out method 1000, and may thus fall within the scope of this disclosure. As with method 1000, Method 1100 may be performed by the execution of instructions stored on a non-transitory computer readable medium. The program instructions may be executable by a computer transaction processing system and perform a number of different operations.

Method 1100 begins with receiving a request to perform a payment transaction that involves a particular merchant (block 1105). While processing the transaction and prior to receiving approval of the payment transaction from a verification process, the method includes performing, using a machine-learning model and a transaction loss budget, an eligibility determination indicating whether the payment transaction is eligible for a subsequent pre-approval determination, wherein the machine-learning model is specific to the particular merchant (block 1110). This may correspond to sub-module 321 of FIG. 4A in some embodiments. Method 1100 further includes using the eligibility determination to perform, prior to the verification process being completed, the pre-approval determination for the payment transaction (block 1115). This may correspond to sub-module 320A in some embodiments. Pre-approval of the payment transaction results in indicating to the particular merchant that the payment transaction is approved, regardless of a result of the verification process (block 1120). Pre-approval is not indicated, in various embodiments, unless a prediction threshold is reached, which as described above, may correspond to an offset prior to a timeout for the merchant initiating the transaction.

In various embodiments, receiving the request to perform the payment transaction and performing the eligibility determination is performed on a first computer system of the computer transaction processing system, wherein the first computer system is configured to receive payment transactions from the particular merchant. Using the eligibility determination to perform the pre-approval determination is completed on a second computer system of the computer transaction processing system, wherein the second computer system is coupled to the first computer system and to external payment processors configured to complete the verification process. Performing the pre-approval determination includes performing an additional eligibility check using different criteria than the eligibility determination.

Embodiments of the method may further includes receiving the request to perform the payment transaction on a first computer system of the computer transaction processing system, wherein the first computer system is configured to receive payment transactions from the particular merchant. Performing the eligibility determination and using the eligibility determination to perform the pre-approval determination in such embodiments is performed on a second computer system of the computer transaction processing system, wherein the second computer system is coupled to the first computer system and to external payment processors configured to complete the verification process.

Using the eligibility determination to perform the pre-approval determination includes, in some embodiments, pre-approving the payment transaction in response to the payment transaction being determined eligible for pre-approval and approaching a timeout threshold for verification of the payment transaction, wherein the timeout threshold corresponds to a quality of service parameter for the particular merchant. It is noted if the verification is completed prior to reaching the timeout threshold, the transaction result is governed by the verification result, even if a prediction has been performed. Using the eligibility determination to perform the pre-approval determination can also include not pre-approving the payment transaction if the verification process completes prior to reaching the timeout threshold or if the transaction loss budget is exceeded or if the pre-approval determination does not indicate pre-approval, wherein the timeout threshold corresponds to a quality of service parameter for the particular merchant. The transaction loss budget may be associated with both the particular merchant and/or a particular payment tenant for the payment transaction in various embodiments, or correspond to an overall loss budget.

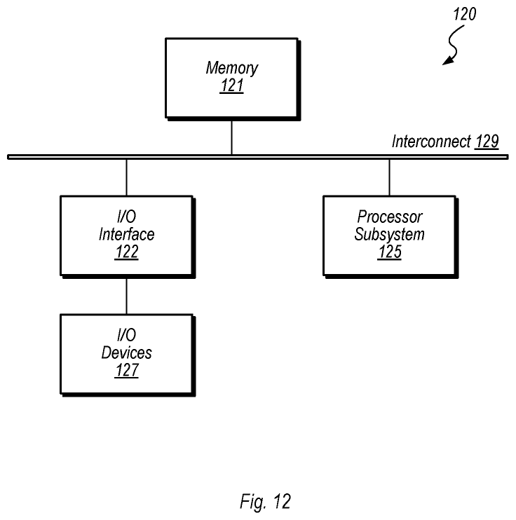

FIG. 12 is a block diagram of one embodiment of an example computer system. Instances of computer system 120 as shown here may be implemented, in various embodiments, at computer system 210A, 210B, or elsewhere in the various transaction processing systems described above.

Computer system 120 includes a processor subsystem 125 that is coupled to a system memory 121 and I/O interfaces(s) 122 via an interconnect 129 (e.g., a system bus). I/O interface(s) 122 is coupled to one or more I/O devices 127. Computer system 120 may be any of various types of devices, including, but not limited to, a server system, personal computer system, desktop computer, laptop or notebook computer, mainframe computer system, tablet computer, handheld computer, workstation, network computer, a consumer device such as a mobile phone, music player, or personal data assistant (PDA). Although a single computer system 120 is shown in FIG. 12 for convenience, system 120 may also be implemented as two or more computer systems operating together.

Processor subsystem 125 may include one or more processors or processing units. In various embodiments of computer system 120, multiple instances of processor subsystem 125 may be coupled to interconnect 129. In various embodiments, processor subsystem 125 (or each processor unit within 125) may contain a cache or other form of on-board memory.

System memory 121 is usable store program instructions executable by processor subsystem 125 to cause system 120 perform various operations described herein. System memory 121 may be implemented using different physical, non-transitory memory media, such as hard disk storage, floppy disk storage, removable disk storage, flash memory, random access memory (RAM-SRAM, EDO RAM, SDRAM, DDR SDRAM, RAMBUS RAM, etc.), read only memory (PROM, EEPROM, etc.), and so on. Memory in computer system 120 is not limited to primary storage such as memory 121. Rather, computer system 120 may also include other forms of storage such as cache memory in processor subsystem 125 and secondary storage on I/O Devices 127 (e.g., a hard drive, storage array, etc.). In some embodiments, these other forms of storage may also store program instructions executable by processor subsystem 125. In some embodiments, memory 121 may include various ones of the modules discussed above, such as prediction module 300A of FIG. 4A, prediction module 300B of FIG. 4B, and/or verification module 305 of FIG. 5, among others.

I/O interfaces 122 may be any of various types of interfaces configured to couple to and communicate with other devices, according to various embodiments. In one embodiment, I/O interface 122 is a bridge chip (e.g., Southbridge) from a front-side to one or more back-side buses. I/O interfaces 122 may be coupled to one or more I/O devices 127 via one or more corresponding buses or other interfaces. Examples of I/O devices 127 include storage devices (hard drive, optical drive, removable flash drive, storage array, SAN, or their associated controller), network interface devices (e.g., to a local or wide-area network), or other devices (e.g., graphics, user interface devices, etc.). In one embodiment, computer system 120 is coupled to a network via a network interface device 127 (e.g., configured to communicate over WiFi, Bluetooth, Ethernet, etc.).

Numerous variations and modifications will become apparent to those skilled in the art once the above disclosure is fully appreciated. It is intended that the following claims be interpreted to embrace all such variations and modifications.

What is claimed is:

1. A method, comprising:
receiving, at a computer system, a particular transaction request, wherein the computer system is configured to perform a verification process to authorize transaction requests;
initiating, by the computer system prior to completion of the verification process for the particular transaction request, a prediction process to predict whether the particular transaction request will pass the verification process, wherein the prediction process utilizes a model specific to a user participating in the particular transaction request;
in response to the prediction process determining that the particular transaction request is predicted to pass the verification process, pre-approving, by the computer system, the particular transaction request such that the particular transaction request is authorized without the verification process;
after the pre-approving, completing, by the computer system, the verification process to determine whether the prediction process was correct for the particular transaction request; and
updating, by the computer system based on a result of the verification process, the model for future transaction requests of the user.

2. The method of claim 1, wherein the prediction process includes a first set of routines executable to determine eligibility for pre-approval of the particular transaction request, wherein the first set of routines is executed prior to beginning the verification process for the particular transaction request; and
wherein the prediction process includes a second set of routines executable to determine, based on an outcome of the first set of routines, whether the particular transaction request is pre-approved.

3. The method of claim 2, wherein the verification process for the particular transaction request is begun after the first set of routines is complete and before the second set of routines is initiated; and
wherein the second set of routines is executed in response to the first set of routines indicating eligibility for pre-approval and a duration of the verification process approaching a specified timeout threshold, wherein the timeout threshold corresponds to a quality of service parameter for the user.

4. The method of claim 2, wherein the first set of routines utilizes the model to determine eligibility for pre-approval.

5. The method of claim 1, wherein the prediction process further utilizes a set of static rules and a transaction loss budget.

6. The method of claim 5, wherein the transaction loss budget takes into account a merchant and a payment tenant participating in the particular transaction request.

7. The method of claim 1, wherein the prediction process utilizes metadata associated with an account of a transaction service that corresponds to a user participating in the particular transaction request.

8. A non-transitory computer-readable storage medium storing program instructions executable by a computer transaction processing system to perform operations comprising:
receiving a request to perform a payment transaction that involves a particular merchant;
prior to receiving approval of the payment transaction from a verification process, performing, using a machine-learning model and a transaction loss budget, an eligibility determination indicating whether the payment transaction is eligible for a subsequent pre-approval determination, wherein the machine-learning model is specific to the particular merchant; and
using the eligibility determination to perform, prior to the verification process being completed, the pre-approval determination for the payment transaction;
wherein pre-approval of the payment transaction results in indicating to the particular merchant that the payment transaction is approved, regardless of a result of the verification process.

9. The computer-readable storage medium of claim 8,
wherein receiving the request to perform the payment transaction and performing the eligibility determination is performed on a first computer system of the computer transaction processing system, wherein the first computer system is configured to receive payment transactions from the particular merchant; and
wherein using the eligibility determination to perform the pre-approval determination is completed on a second computer system of the computer transaction processing system, wherein the second computer system is coupled to the first computer system and to external payment processors configured to complete the verification process.

10. The computer-readable storage medium of claim 9, wherein performing the pre-approval determination includes performing one or more checks that use different criteria than the eligibility determination.

11. The computer-readable storage medium of claim 8,
wherein receiving the request to perform the payment transaction is performed on a first computer system of the computer transaction processing system, wherein the first computer system is configured to receive payment transactions from the particular merchant; and
wherein performing the eligibility determination and using the eligibility determination to perform the pre-approval determination is performed on a second computer system of the computer transaction processing system, wherein the second computer system is coupled to the first computer system and to external payment processors configured to complete the verification process.

12. The computer-readable storage medium of claim 8, wherein using the eligibility determination to perform the pre-approval determination includes pre-approving the payment transaction in response to:
the payment transaction being determined eligible for pre-approval; and
approaching a timeout threshold for verification of the payment transaction, wherein the timeout threshold corresponds to a quality of service parameter for the particular merchant.

13. The computer-readable storage medium of claim 8, wherein using the eligibility determination to perform the pre-approval determination includes:
not pre-approving the payment transaction if the verification process completes prior to approaching a timeout threshold or if the transaction loss budget is exceeded or if the pre-approval determination does not indicate pre-approval;
wherein the timeout threshold corresponds to a quality of service parameter for the particular merchant.

14. The computer-readable storage medium of claim 8, wherein the transaction loss budget is associated with both the particular merchant and a particular payment tenant for the payment transaction.

15. A transaction processing system, the system comprising:
a first computer system configured to process user transactions using without utilizing user metadata associated with accounts of a transaction service; and
a second computer system coupled to the first computer system via an application programming interface and configured to process user transactions utilizing user metadata associated with accounts of the transaction service,
wherein the first computer system is configured to receive a particular transaction request of a user; and
wherein the first and second computer systems are configured to, prior to completing a verification process for the particular transaction request, initiate a prediction process to determine whether to pre-approve the particular transaction request, wherein the prediction process uses a machine-learning model.

16. The transaction processing system of claim 15,
wherein the first computer system, in response to determining that the particular transaction request is not associated with an account of the transaction service, is configured to:
perform a first portion of the prediction process utilizing the machine-learning model, wherein the machine-learning model is specific to a user in the particular transaction request;
send, to the second computer system via the application programming interface, a timeout threshold specific to the participant and a result of the first portion of the prediction process; and
wherein the second computer system, in response to the verification process approaching the timeout threshold, is configured to execute a second portion of the prediction process that utilizes the result of the first portion to determine whether to pre-approve the particular transaction request.

17. The transaction processing system of claim 15,
wherein the first computer system, in response to determining that the particular transaction request is not associated with an account of the transaction service, is configured to send a timeout threshold associated with the particular transaction request to the second computer system via the application programming interface; and
wherein the second computer system, in response to the verification process exceeding the timeout threshold, is configured to perform the prediction process using the machine-learning model to determine whether to pre-approve the particular transaction request, wherein the machine-learning model is specific to a user in the particular transaction request.

18. The transaction processing system of claim 15, wherein the second computer system, in response to an indication that the particular transaction request is associated with a particular account of the transaction service corresponding to a user, is configured to execute the second portion of the prediction process in a manner that does not utilize the result of the first portion to determine whether pre-approve the particular transaction request.

19. The transaction processing system of claim 15,
wherein the first computer system, in response to determining that the particular transaction request is associated with a particular account of the transaction service corresponding to a user, is configured to:
request, from the second computer system via the application programming interface, user metadata associated with the particular account;
perform a first portion of the prediction process utilizing the machine-learning model and the user metadata, wherein the machine-learning model is specific to the user;
send, to the second computer system via the application programming interface, a result of the first portion of the prediction process; and
wherein the second computer system is configured to execute a second portion of the prediction process to determine whether to pre-approve the particular transaction request.

20. The transaction processing system of claim 15,
wherein the first computer system is configured to send the particular transaction to the second computer system via the application programming interface, and
wherein the second computer system is configured to perform the prediction process using both account metadata and the machine-learning model to determine whether to pre-approve the particular transaction request, wherein the account metadata is associated with an account of a user for a payment service, and wherein the machine-learning model is specific to the user.
